(19) United States
(12) Patent Application Publication
(10) Pub. No.: US 2007/0097068 A1
(43) Pub. Date: May 3, 2007

(54) Display apparatus and information processing apparatus

(75) Inventors: Makoto Tanaka, Ome-shi (JP); Yuichi Koga, Hachioji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/522,474

(22) Filed: Sep. 18, 2006

(30) Foreign Application Priority Data
Oct. 31, 2005 (JP) 2005-317533

(51) Int. Cl. G09G 3/36

(52) U.S. Cl. 345/102

(57) ABSTRACT

According to one embodiment, a display apparatus includes a display panel, a light emitting element arranged as a light source for the display panel, a board on which a first circuit for controlling power supply to the light emitting element is arranged, and a second circuit which is arranged on the board, and executes a process unrelated to a drive process of the display panel.

### CROSS-REFERENCE TO RELATED APPLICATIONS

This application is based upon and claims the benefit of priority from Japanese Patent Application No. 2005-317533, filed Oct. 31, 2005, the entire contents of which are incorporated herein by reference.

### BACKGROUND

1. Field

One embodiment of the invention relates to a display apparatus using a backlit liquid crystal display panel, and an information processing apparatus having the display apparatus.

2. Description of the Related Art

It is disclosed by, for example, Jpn. Pat. Appln. KOKAI Publication No. 2002-72234 to develop a liquid crystal display apparatus which uses a light emitting element such as an LED as a backlight light source, instead of a fluorescent tube.

A portable information processing apparatus having this type of liquid crystal display apparatus requires a circuit packaging technique for increasing the number of functions.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block diagram showing the arrangements of a display apparatus and an information processing apparatus according to a first embodiment of the invention;

FIG. 2 is a block diagram showing the arrangements of the display apparatus and the information processing apparatus according to the first embodiment;

FIG. 3 is a perspective view showing the outer appearance of a more practical information processing apparatus according to a second embodiment of the invention;

FIG. 4 is a block diagram showing the system configuration of the more practical information processing apparatus according to the second embodiment;

FIG. 5 is a block diagram showing the arrangements of a display apparatus and an information processing apparatus according to a third embodiment of the invention; and

FIG. 6 is a block diagram showing the arrangements of a display apparatus and an information processing apparatus according to a fourth embodiment of the invention.

### DETAILED DESCRIPTION

Various embodiments according to the invention will be described hereinafter with reference to the accompanying drawings. In general, according to one embodiment of the invention, there is provided a display apparatus comprising a display panel, a light emitting element arranged as a light source for the display panel, a board on which a first circuit for controlling power supply to the light emitting element is arranged, and a second circuit which is arranged on the board and executes a process unrelated to a drive process of the display panel.

According to another embodiment of the invention, there is provided an information processing apparatus comprising a main body which incorporates a first board, and a display unit arranged to be pivotal with respect to the main body. Note that the display unit further comprises a display panel, a light emitting element arranged as a light source for the display panel, a second board on which a first circuit for controlling power supply to the light emitting element is arranged, and a second circuit which is arranged on the second board and connected to a circuit arranged on the first board, and which executes a process unrelated to a drive process of the display panel.

According to an embodiment, FIG. 1 shows the arrangements of a display apparatus and an information processing apparatus using this display apparatus according to the first embodiment of the present invention.

The information processing apparatus according to the embodiment of the present invention has a main body 10 serving as a main part of the information processing apparatus, and a display unit 20 serving as a display apparatus. The display unit 20 is supported to be pivotal about a hinge unit 30 with respect to the main body 10. The main body 10 has a system circuit board 11. A system circuit 12A including a CPU, its peripheral circuit, various buses, and various controllers connected to these buses is arranged on the system circuit board 11.

The display unit 20 has an liquid crystal display (LCD) panel 21, and a sub-board (circuit board) 23 associated with the LCD panel 21. The LCD panel 21 has a backlight 22 using an LED as a light source.

A backlight power supply circuit (LED/BL-PS) 24 which on/off-drives the LED serving as the light source for the backlight 22 is arranged on the sub-board 23. An additional circuit 25 unrelated to driving of the LCD is also arranged on the sub-board 23. The additional circuit 25 comprises a user interface (IF) 26. The user interface 26 has a user interface function of handling a signal input to the system circuit board 11, and that of handling a signal to be output from the system circuit board 11. Alternatively, the user interface 26 has one of these user interface functions.

The additional circuit 25 which is arranged on the sub-board 23 and comprises the user interface 26 is electrically connected to the system circuit board 11 arranged in the main body 10. Such electrical connection is established using a signal line extending through a through hole formed in the hinge unit 30. This signal line is, e.g., a serial bus connected to a serial bus interface, an analog signal line, or a USB cable. When the through hole has a large diameter, the signal line may be a parallel bus having a width of a plurality of bits. The serial bus is suitable to be applied when the number of signal lines extending through the through hole in the hinge unit 30 is strictly limited.

The serial bus can be applied when the number of signal lines extending through the through hole in the hinge unit 30 is limited in the circuit arrangement in which a digital signal such as a command and data is transferred between the system circuit board 11 and the additional circuit 25. For example, the serial bus can be applied to the following circuit arrangement. In this circuit arrangement, a digital signal is transmitted from an I/O controller 12B on the system circuit board 11 in the main body 10 to the additional circuit 25 on the sub-board 23 in the display unit 20. The additional circuit 25 then digital-to-analog-converts the transmitted digital signal, and outputs the converted signal to the user interface 26. Alternatively, the serial bus can be applied to the circuit arrangement in which the additional circuit 25 generates a command (or data) according to the operation state of the user interface 26, and transmits the generated command to the system circuit board 11.

The analog signal line can be applied when various analog signals related to the user interface are transmitted/received between the system circuit board 11 and the additional circuit 25. For example, the analog signal line can be applied to the following circuit arrangement. In this circuit arrangement, the I/O controller 12B arranged on the system circuit board 11 transmits a digital-to-analog-converted signal (e.g., audio signal) to the additional circuit 25. The additional circuit 25 then analog-amplifies the transmitted signal, and outputs the amplified signal to the user interface 26. Alternatively, the analog signal line can be applied to the circuit arrangement in which the additional circuit 25 analog-amplifies the analog signal (e.g., microphone input signal) from the user interface 26 to transmit the amplified signal to the system circuit board 11, and the system circuit board 11 analog-to-digital-converts the above analog signal to input the converted signal.

When the USB cable is used, video, audio, and operation instruction signals handled by the user interface can be transmitted/received between the system circuit board 11 and the additional circuit 25 by performing isochronous transfer to transfer sound data, image data, and the like between the system circuit board 11 and the additional circuit 25, and interrupt transfer to transfer pointing device data from the additional circuit 25 to the system circuit board 11.

The following circuit arrangement can also be implemented. In this circuit arrangement, a control circuit (CNT) 29 which comprises a microprocessor and controls data transfer between the sub-board 23 and the system circuit board 11 is arranged on the sub-board 23. Under the control of the control circuit 29, each of the backlight power supply circuit 24 and additional circuit 25 on the sub-board 23 transmits/receives data to/from the system circuit board 11. In this case, the signal line can be shared. As another example, the control circuit 29 can also control both or one of the backlight power supply circuit 24 and additional circuit 25 on the sub-board 23. For example, one of the following two processing functions can be implemented: inputting reception data from the system circuit board 11 to the control circuit 29 to execute a predetermined process, and transmitting the processed data to the additional circuit 25 and the system circuit board 11; and processing the data from the additional circuit 25 to perform input/output control for the user interface 26, and transmitting the processed data to the system circuit board 11. Note that the control circuit 29 is arranged on the sub-board 23 alone. However, the present invention is not limited to this. For example, the control circuit 29 may be incorporated in the additional circuit 25 or the backlight power supply circuit 24.

As described above, the additional circuit 25 with the user interface 26 is arranged on the sub-board 23 on which the backlight power supply circuit 24 is arranged. In this arrangement, when a new functional circuit is to be added in order to increase the number of functions, the functional circuit with the user interface 26 can be arranged as the additional circuit 25 in the display unit 20 without ensuring a mounting space on the system circuit board 11 or without ensuring a board mounting space in the display unit 20. Accordingly, a multifunctional apparatus can be easily implemented (the function can be extended) without degrading operability.

Also, the number of functions can be increased using an economically advantageous circuit packaging means without degrading operability. For example, when the LED is used for the backlight light source for a backlit LCD panel in place of the fluorescent (FL) tube, the backlight power supply circuit which handles a high-voltage power supply for on/off-driving the fluorescent tube need not be mounted on the backlight power supply circuit board (sub-board) associated with the LCD panel. The backlight power supply circuit is replaced with a small-scale and low-voltage circuit for on/off-driving the LED. Hence, a sufficient mounting space for mounting another functional circuit can be ensured on the backlight power supply circuit board. A sufficient wiring space can also be ensured in the through hole in the hinge unit. Accordingly, both of the backlight power supply circuit and the functional circuit with the user interface can be arranged on the backlight power supply circuit board (sub-board) without ensuring a new board mounting space in the display unit. As a result, the design of the display unit and main body need not be largely changed, and the function can be extended by the additional circuit in an economically advantageous arrangement in which the present sub-board or the board mounting space is efficiently used.

When connection plugs such as a connector, plug, and jack, and user interfaces including operation devices such as a jog dial and switch to be used by the user are mounted on the display unit housing, the function can be extended by the additional circuit with excellent operability, without ensuring a new mounting space for the user interface in the main body to extend the function.

When some functional circuits mounted on the system circuit board 11 are moved as the above additional circuits to the sub-board in the display unit, a new functional circuit can be added to the system circuit board 11. Additionally, when the above display unit 20 is applied to a tablet information processing apparatus, a multifunctional tablet information processing apparatus with excellent operability can be implemented.

The second embodiment of the present invention as a more practical example of the first embodiment of the present invention will be described below.

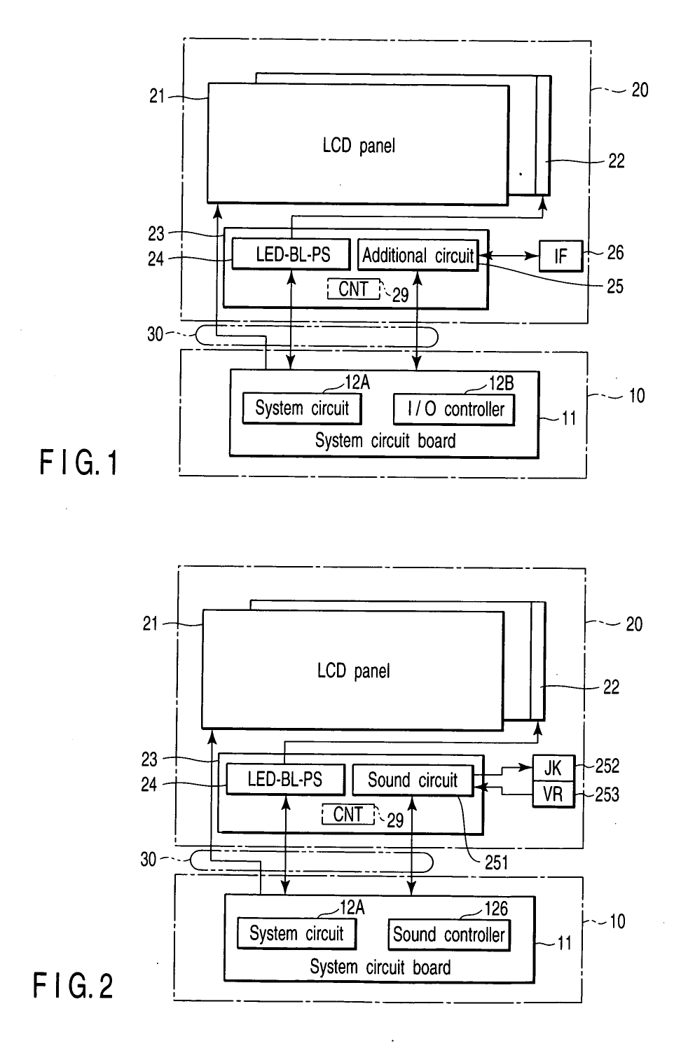

FIG. 2 shows the arrangements of a display apparatus and an information processing apparatus using the display apparatus according to the second embodiment of the present invention. The second embodiment exemplifies the arrangement in which a sound circuit 251 is arranged as an additional circuit on a sub-board 23. Note that the same reference numerals in FIG. 2 denote the same components as those in FIG. 1, and a description thereof will be omitted.

In addition to a backlight power supply circuit 24 which on/off-drives the LED as the light source for a backlight 22, the sound circuit 251 as the additional circuit is arranged on the sub-board 23 in a display unit 20. The sound circuit 251 comprises an audio jack (JK) 252 used by a user, and a variable controller (VR) 253 operated by the user, as user interfaces. The audio jack (JK) 252 is, e.g., a headphone jack or microphone jack. The variable controller 253 is, e.g., a variable resistor for adjusting volume control, or an operation device such as a jog dial.

The sound circuit 251 which is arranged on the sub board 23 and comprises the audio jack 252 and the variable controller 253 is electrically connected to a sound controller 126 arranged on a system circuit board 11 in a main body 10.

The second embodiment implements a functional circuit which can input/output various audio signals handled by the user interface to/from the system circuit board 11 via the sound circuit 251 arranged on the sub-board 23.

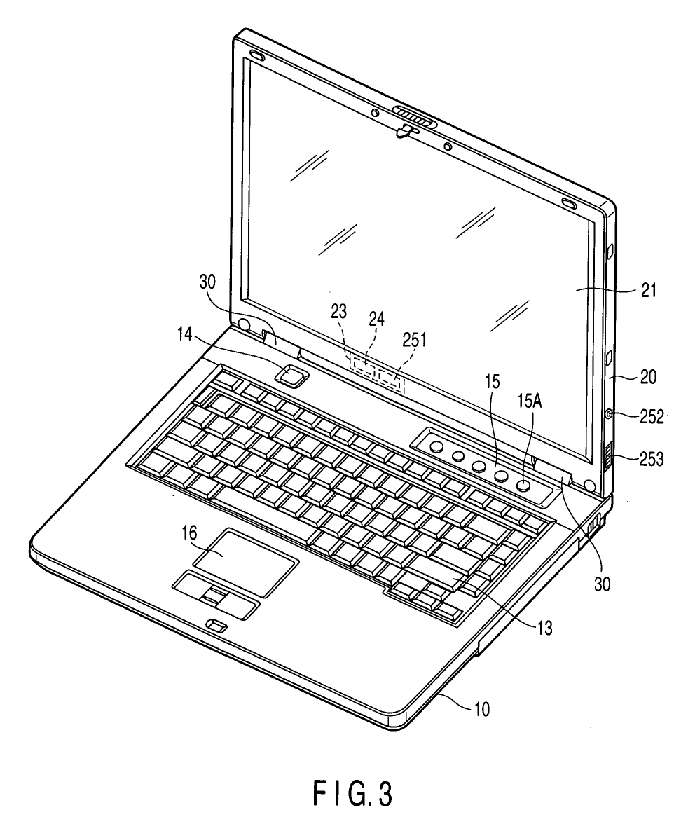

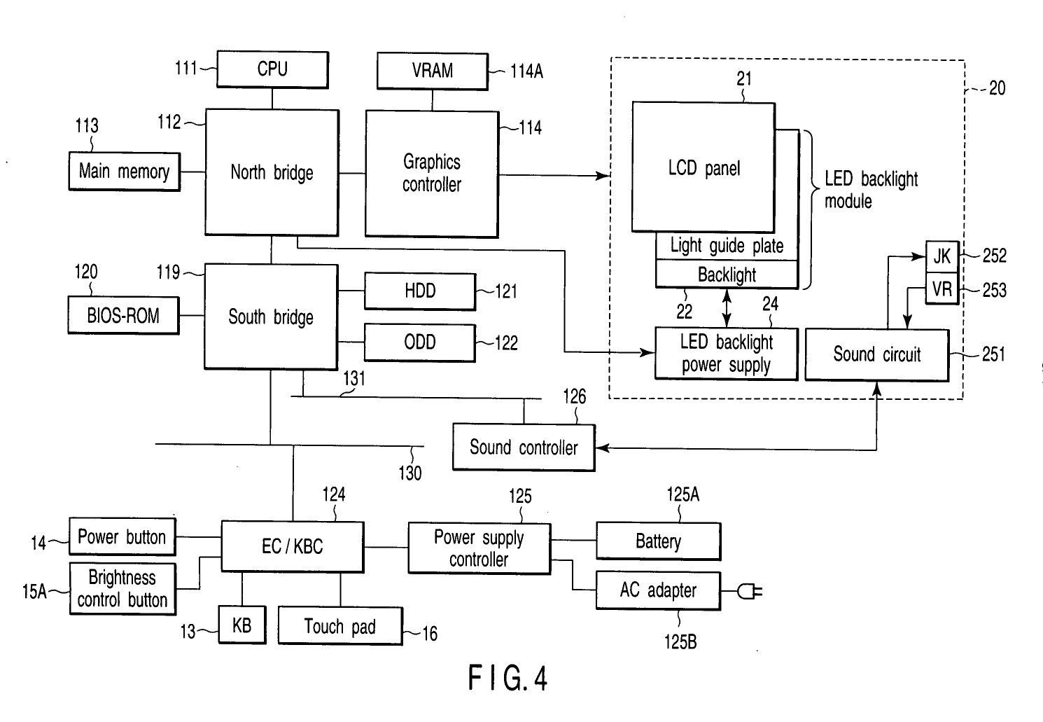

FIGS. 3 and 4 show the arrangements of the information processing apparatus as a more practical example of the second embodiment.

FIG. 3 shows the outer appearance of a more practical information processing apparatus according to the second embodiment. In FIG. 3, a battery-drivable and portable notebook personal computer is exemplified. This personal computer comprises the main body 10 and the display unit 20.

The display unit 20 is supported to be pivotal about a hinge unit 30 with respect to the main body 10. The display unit 20 incorporates, in its housing, a transparent LCD panel 21 whose display surface is exposed from the front surface of the housing. The backlight 22 using an LED as a light source shown in FIG. 2 is arranged on the back surface of the LCD panel 21. The audio jack 252 and variable controller 253 connected to the sound circuit 251 shown in FIG. 2 are also formed on the side surface of the housing of the display unit 20, in a state wherein a jack, operation dial, and the like are exposed from the housing.

The main body 10 has a low-profile box-shaped housing. On the top surface of the housing, a keyboard 13, a power button 14 used to turn on/off a system power supply, an input operation panel 15, a touch pad 16, and the like are arranged. The input operation panel 15 is an input device used to input an event corresponding to a pressed button, and has a plurality of buttons for activating respective functions. The button group also includes a brightness control button 15A. The brightness control button 15A is a button switch used to adjust the display brightness of the LCD panel 21, i.e., the brightness of the LED serving as the light source for the backlight 22.

FIG. 4 shows the internal arrangement of the main body 10 and display unit 20 shown in FIG. 3.

As shown in FIG. 2, the system circuit board 11 in the housing of the main body 10 comprises a CPU 111, north bridge 112, main memory 113, graphics controller 114, south bridge 119, BIOS-ROM 120, hard disc drive (HDD) 121, optical disc drive (ODD) 122, embedded controller/keyboard controller (EC/KBC) IC 124, power supply controller 125, sound controller 126, and the like.

The power supply controller 125 is connected to a battery 125A and an AC adapter 125B, controls power from the battery 125A or the AC adapter 125B to be a predetermined value, and supplies power to the EC/KBC 124.

The CPU 111 is a processor which controls operations of the system. The CPU 111 executes an operating system (OS) and various application programs which are loaded from the hard disc drive (HDD) 121 onto the main memory 113 via the south bridge .119 and the north bridge 112. The CPU 111 also executes a Basic Input Output System (BIOS) stored in the BIOS-ROM 120. The BIOS is a program for hardware control. In this case, under the control of the BIOS in accordance with the operation of the brightness control button 15A, the backlight power supply circuit 24 arranged on the sub-board 23 controls the display brightness (the light quantity of the LED) of the backlight 22 for the LCD panel 21.

The north bridge 112 is a bridge device that connects the local bus of the CPU 111 and the south bridge 119. The north bridge 112 incorporates a memory controller that executes access control for the main memory 113. The north bridge 112 also has a function of making a communication with the graphics controller 114 via an Accelerated Graphics Port (AGP) bus or the like.

The graphics controller 114 is a display controller which controls the LCD panel 21 of the display unit 20. The graphics controller 114 has a video memory (VRAM) 114A, and generates a video signal for forming a display image to be displayed on the LCD panel 21 of the display unit 20, in accordance with the display data written in the video memory 114A by the OS/application program.

The south bridge 119 controls each device on an Low Pin Count (LPC) bus. The south bridge 119 incorporates an Integrated Drive Electronics (IDE) controller for controlling the HDD 121 and ODD 122. The south bridge 119 also has a function of executing access control for the BIOS-ROM 120.

Various I/O controllers including the sound controller 126 are connected to the south bridge 119 via a PCI bus 131. The sound controller 126 connected to the south bridge 119 via the PCI bus 131 performs input/output control for sound data or an analog sound signal under the control of the application program which handles sound information. The sound controller 126 is electrically connected to the sound circuit 251 on the sub-board 23 via a predetermined bus or signal line.

The HDD 121 is a storage device for storing various software and data. In the HDD 121, the above-described operating system and various application systems are stored. The optical disc drive (ODD) 122 is a drive unit for driving a storage medium such as a DVD and CD in which video content is stored.

The embedded controller/keyboard controller (EC/KBC) IC 124 is a 1-chip microcomputer on which an embedded controller for power management, and a keyboard controller that controls the keyboard (KB) 13 and touch pad 16 are integrated. When the user presses the brightness control button 15A, the embedded controller/keyboard controller (EC/KBC) IC 124 generates an interruption signal such as an System Management Interrupt (SMI) in order to notify the BIOS that a display brightness switching event is input.

The embedded controller/keyboard controller (EC/KBC) IC 124 has a function of turning on/off the power of the computer 10 in response to user's operation of the power button 14 in collaboration with the power supply controller 125.

The backlight power supply circuit 24 arranged on the sub-board 23 in the display unit 20 on/off-drives the light source for the backlight 22 arranged on the back surface of the transparent LCD panel 21. The backlight 22 has a plurality of LEDs serving as light sources for the backlight 22, and a light guide plate which uniformly illuminates the back surface of the LCD panel 21 with light emitted from each LED.

The sound circuit 251 arranged on the sub-board 23 in the display unit 20 comprises the audio jack 252 and variable controller 253 as the user interfaces. The sound circuit 251 is electrically connected to the sound controller 126 via the bus or signal line extending through the hinge unit 30.

The sound circuit 251 implements an interface circuit function for supplying sound information (digital sound data or an analog sound signal) from the sound controller 126 to the user. The sound circuit 251 also implements an interface circuit function for converting the sound information received from the user into a signal form which can be input by the sound controller 126, and transmits the converted information to the sound controller 126.

The detailed circuit function of the sound circuit 251 will be exemplified below.

As the first example, the sound circuit 251 realizes a circuit function of converting (decoding) digital sound data from the sound controller 126 into the analog sound signal, amplifying the converted signal to a sound level according to the operation instruction from the variable controller 253, and outputting the amplified signal to the audio jack 252. In this case, such electrical connection between the sound controller 126 and the sound circuit 251 may be serial bus connection, parallel bus connection, or USB cable connection.

As the second example, the sound circuit 251 realizes a circuit function of inputting the analog sound signal from the sound controller 126, amplifying the input signal to the sound level according to the operational instruction from the variable controller 253, and outputting the amplified signal to the audio jack 252. In this case, electrical connection between the sound controller 126 and the sound circuit 251 may be signal line connection for transmitting the analog signal.

As the third example, the sound circuit 251 realizes a circuit function of amplifying a microphone signal from the audio jack 252 to a predetermined level, converting the amplified signal into the digital signal form which can be input by the sound controller 126, and supplying the converted signal to the sound controller 126. In this case, electrical connection between the sound controller 126 and the sound circuit 251 may be serial bus connection, parallel bus connection, or USB cable connection.

As the fourth example, the sound circuit 251 realizes a circuit function of amplifying the microphone signal from the audio jack 252 to the sound level according to the operational instruction from the variable controller 253, and supplying the amplified signal as the analog sound signal to the sound controller 126. In this case, electrical connection between the sound controller 126 and the sound circuit 251 may be signal line connection for transmitting the analog signal.

The above-described various circuit functions are combined, as needed, in accordance with the specification of the user interface to extend a desired sound function on the sub-board 23.

As described above, the sound circuit 251 with the user interfaces is arranged on the sub-board 23 having the backlight power supply circuit 24. Hence, when a new functional circuit is to be added in order to increase the number of functions, the sound functional circuit with the user interfaces can be arranged as the additional circuit in the display unit 20 without ensuring the mounting space on the system circuit board 11, and without ensuring a new board mounting space in the display unit 20. This easily increases the number of functions without degrading operability.

FIG. 5 shows the arrangements of a display apparatus and an information processing apparatus using the display apparatus as a more practical example of the first embodiment of the present invention according to the third embodiment of the present invention. The third embodiment exemplifies an arrangement in which a USB power supply circuit 261 is arranged as an additional circuit for a USB port on a sub-board 23. Note that the same reference numerals in FIG. 5 denote the same components as those in FIG. 1, and a description thereof will be omitted.

In addition to a backlight power supply circuit 24 which on/off-drives an LED serving as a light source for a backlight 22, the USB power supply circuit 261 is arranged as the additional circuit on the sub-board 23 in a display unit 20. The USB power supply circuit 261 comprises two USB connectors 262 and 263 as user interfaces.

The USB power supply circuit 261 has a circuit function of performing power supply control for the USB connectors 262 and 263, and transmitting/receiving a USB input/output signal between each of the USB connectors 262 and 263 and an I/O controller 12B having a USB interface on a system circuit board 11.

As a result, the USB port can be easily added, as needed. Since the USB connectors 262 and 263 are mounted on the housing of the display unit 20, various USB devices can be used independently of the state of a main body 10. For example, when the USB connectors 262 and 263 are formed on the side or back surface of the housing of the display unit 20, the USB devices can be easily used when the display unit 20 is opened or closed with respect to the main body 10.

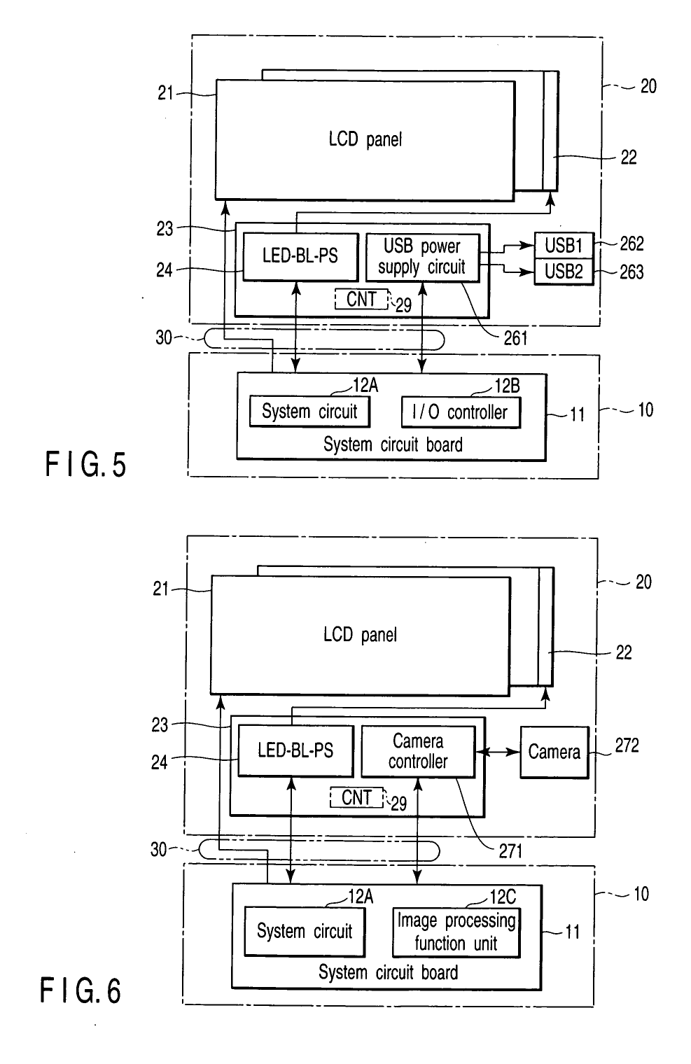

FIG. 6 shows the arrangements of a display apparatus and an information processing apparatus using the display apparatus according to the fourth embodiment of the present invention as a more practical example of the first embodiment of the present invention. The fourth embodiment exemplifies an arrangement in which an interface circuit (camera controller) 271 having an image sensing camera is arranged as an additional circuit on a sub-board 23. Note that the same reference numerals in FIG. 6 denote the same components as those in FIG. 1, and a description thereof will be omitted.

The camera controller 271 serving as the additional circuit is arranged on the sub-board 23 in a display unit 20, in addition to a backlight power supply circuit 24 which on/off-drives an LED serving as the light source for a backlight 22. The camera controller 271 comprises an image sensing camera 272.

The camera controller 271 converts image data sensed by the camera 272 into the input format of an image processing function unit 12C arranged on a system circuit board 11, and transmits the converted data to the system circuit board 11 via, e.g., a USB cable.

Since the camera controller 271 with the camera 272 is arranged as the additional circuit on the sub-board 23 in the display unit 20, a camera function can be easily extended independently of the state of a main body 10.

The above-described embodiments can be applied not only to a portable computer as shown in FIG. 3 but also to various information processing devices which require display units 20. For example, when an embodiment is applied to a tablet information processing apparatus, a multifunctional tablet information processing apparatus with excellent operability can be implemented.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display apparatus comprising:
a display panel;
a light emitting element arranged as a light source for the display panel;
a board on which a first circuit for controlling power supply to the light emitting element is arranged; and
a second circuit which is arranged on the board, and executes a process unrelated to a drive process of the display panel.

2. An apparatus according to claim 1, which further comprises an interface configured to be connected to an external device, and in which the second circuit is connected to the interface.

3. An apparatus according to claim 2, wherein the second circuit includes one of a circuit for processing a sound signal, a circuit for controlling a USB power supply, and a circuit for processing an image signal.

4. An apparatus according to claim 1, further comprising a controller which is arranged on the board, and controls at least one of the first circuit and the second circuit.

5. An information processing apparatus comprising:
a main body which incorporates a first board; and
a display unit arranged to be pivotal with respect to the main body,
the display unit further comprising
a display panel,
a light emitting element arranged as a light source for the display panel,
a second board on which a first circuit for controlling power supply to the light emitting element is arranged, and
a second circuit which is arranged on the second board, is connected to a circuit arranged on the first board, and executes a process unrelated to a drive process of the display panel.

6. An apparatus according to claim 5, wherein the display unit further comprises an interface configured to be connected to an external device, and
the second circuit is connected to the interface.

7. An apparatus according to claim 5, wherein the display unit further comprises an interface configured to be connected to an external device, and
the interface inputs a signal transmitted to a circuit on the first board via the second circuit, or outputs a signal transmitted from the circuit on the first board via the second circuit.

8. An apparatus according to claim 5, wherein the second circuit includes one of a circuit for processing a sound signal, a circuit for controlling a USB power supply, and a circuit for processing an image signal.

9. An apparatus according to claim 5, which further comprises a hinge mechanism which connects the main body to the display unit, and in which the second circuit is connected to a circuit on the first board via the hinge mechanism.

10. An apparatus according to claim 5, further comprising a controller which is arranged on the second board, and controls at least one of the first circuit and the second circuit.
